(19) United States
(12) Patent Application Publication
(10) Pub. No.: US 2013/0290442 A1
(43) Pub. Date: Oct. 31, 2013

(54) DOWNLOADED ATTACHMENTS FLOW

(71) Applicant: Moshe DGANI, Holon (IL)

(72) Inventor: Moshe DGANI, Holon (IL)

(73) Assignee: Emoze Ltd., Herzeliya Pituach (IL)

(21) Appl. No.: 13/556,582

(22) Filed: Jul. 24, 2012

Related U.S. Application Data
(60) Provisional application No. 61/640,014, filed on Apr. 30, 2012.

(51) Int. Cl. G06F 15/16

(52) U.S. Cl. 709/206

(57) ABSTRACT

A system and method for organizing and accessing attachments to messages from a plurality of different message accounts in a single location. A plurality of attachments to messages from a plurality of different message accounts are downloaded by a mobile device, and a plurality of links for the plurality of attachments are displayed in a single location by the mobile device.

### CROSS-REFERENCE TO RELATED APPLICATION

This application claims the benefit of U.S. Provisional Application No. 61/640,014, filed Apr. 30, 2012.

### BACKGROUND

1. Field of Disclosure

Example embodiments of the present invention relate to attachments to messages and, in particular, to systems and methods for organizing and accessing attachments to messages in a mobile device.

2. Description of Related Art

A user may maintain multiple email accounts and access the multiple accounts from a mobile device. For example, the user may have a personal email account, e.g., a Gmail account, and a work email account, e.g., a Microsoft Exchange based account. The user may receive email messages that include attachments in each of the multiple accounts. Moreover, the user, through the mobile device, may receive various other types of messages, for example, SMS messages and/or instant messages for a chat program, which include attachments.

It is inconvenient and difficult for the user to search through the large number and different types of messages that the user has received to find a particular attachment on the mobile device. For example, the user may be required to perform multiple clicks/selections and/or access multiple screens to open the attachment that they are searching for on the mobile device. Furthermore, because mobile devices have a limited internal storage capacity, they maintain an “expiration policy” for emails and/or other messages that deletes older emails and messages after a predetermined period of time, e.g., three days, one week, one month, has passed, or after a predetermined number of emails are heaped in a particular mail folder, e.g., in an Inbox. Accordingly, an attachment to an email or message may be lost if the mobile device executes the “expiration policy” to delete the older emails or messages.

Conventional mobile devices and processes for accessing mobile email, e.g., the native mail applications in Apple's iOS and Google's Android OS, do not provide a convenient mechanism for accessing attachments. The user must instead search through each email account individually to find the attachment the user is looking for on the mobile device.

### SUMMARY OF THE INVENTION

Example embodiments provide a system and method for organizing and accessing attachments to messages in a single location, e.g., in a single application and/or in a single application display or window, to provide a convenient mechanism for accessing attachments from a plurality of different messaging accounts.

According to an example embodiment, a method for organizing and accessing attachments to messages comprises downloading, by a mobile device, a plurality of attachments to messages from a plurality of different message accounts and displaying, by the mobile device, a plurality of links for the plurality of attachments by a single application in a single location, e.g., in a single application and/or in a single application display or window.

According to another example embodiment, system for organizing and accessing attachments to messages on a mobile device comprises a download unit and a display unit. The download unit is configured to download to the mobile device a plurality of attachments to messages from a plurality of different message accounts. The display unit is configured to display on the mobile device a plurality of links for the plurality of attachments by a single application in a single location.

According to still another example embodiment, a non-transitory computer readable medium stores a computer program which when executed by a processor of a mobile devices causes the processor to execute steps of a method for organizing and accessing attachments to messages. The method comprises downloading a plurality of attachments to messages from a plurality of different message accounts and displaying a plurality of links for the plurality of attachments by a single application in a single location.

### BRIEF DESCRIPTION OF THE DRAWING FIGURES

These and other objects, features and advantages of the invention will be apparent from a consideration of the following Detailed Description of the Invention considered in conjunction with the drawing Figures, in which:

FIG. 1 shows an example display of links for downloaded attachments according to an example embodiment;

FIG. 2 is an example display of an email of an email account that contains attachments and an attachment resulting opened by a user selecting a preview option;

FIG. 3 is an example display of an email of an email account with attachments and an example display of links for downloaded attachments;

FIG. 4 is another example display of an email of an email account with attachments and a “save as” option allowing a user to select a folder to download an attachment;

FIG. 5 is an example display showing playback of a downloaded attachment;

FIG. 6 is still another example display of an inbox for an email account.

FIG. 7 is another example display of links for downloaded attachments according to an example embodiment;

FIG. 8 is an example display of an email opened directly from a display of links for downloaded attachments according to an example embodiment; and

FIG. 9 is a flow chart showing a method for downloading, organizing and accessing attachments to messages according to an example embodiment.

### DETAILED DESCRIPTION OF EMBODIMENTS OF THE INVENTION

A device according to an example embodiment may include a processor, a memory, a display, a user input component and a communication portal. The display may comprise the user input component as a touch screen display. The device may be a mobile device, for example, a mobile terminal, or any other device configured to wirelessly access one or more email accounts of a user and/or to receive various other types of messages, e.g., SMS messages, instant messages from a chat program or messages from a social network. For example, the mobile device may be a mobile terminal, a smartphone, a tablet computer, a laptop computer, etc. The mobile device may execute any known operating system, for example, Apple's iOS or Google's Android operating system. A Downloaded Attachments application according to example embodiments organizes links (virtual or physical) to all attachments downloaded by the user on the mobile device from all of the email accounts and email folders of the user and/or other messaging services that the user has accessed.

Attachments may be downloaded and stored in a memory location on the mobile device selected by the user. For example, various email applications for mobile devices provide the user with “Save As” functionality that allows the user to select the folder on the mobile device where the attachment is to be downloaded and saved. In other applications, the file system is hidden from the user (e.g., in Apple's iOS) and, therefore, the user is not able to select a specific memory location to which the attachment is downloaded and saved. The email application may instead manage a memory location for the downloaded attachments without providing the user the ability to access the files from a File Browser or another application other than the email application itself. Other applications may provide a hybrid system that provides the user an option to download and save the attachment to a specific memory location, but also allows the user to “Open/Preview” the attachment without selecting the specific memory location. For example, if the user simply opens/previews the attachment, the application/system downloads the attachment to a memory location that is unknown to the user and which the application manages by itself. The downloaded attachment may only be temporarily saved at the memory location if the user simply opens/previews the attachment. For example, the downloaded attachment may be automatically deleted from the memory location if the user closes the opened/previewed attachment. Although downloading and saving of attachments is described with respect to downloading and saving to memory locations on the mobile device, example embodiments are not limited thereto and the mobile device may download and save the applications to storage or memory locations on another device or a server, e.g., in the “Cloud”.

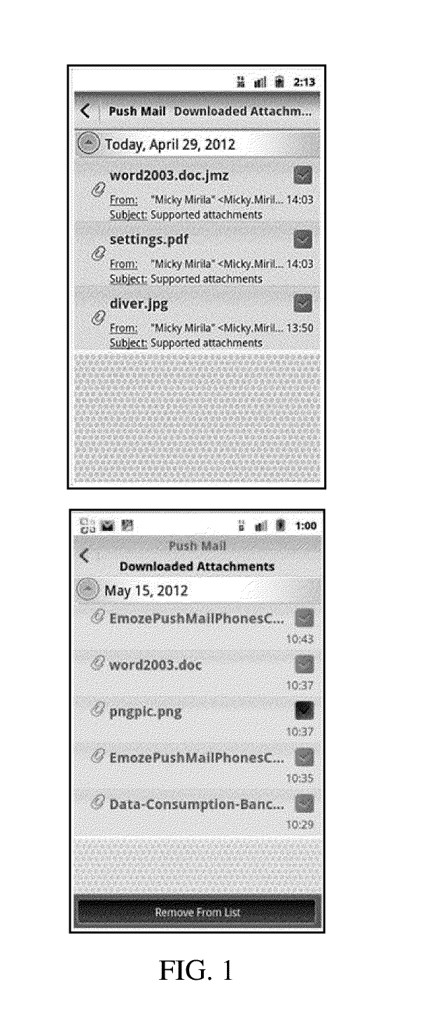

FIG. 1 is an example display of links for downloaded attachments displayed by a Downloaded Attachments application according to an example embodiment

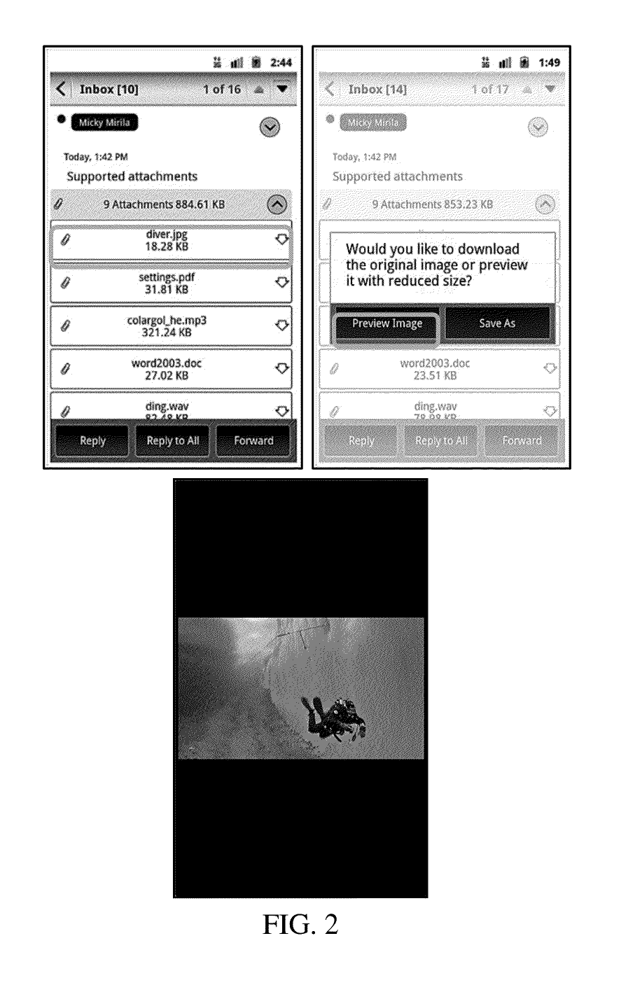

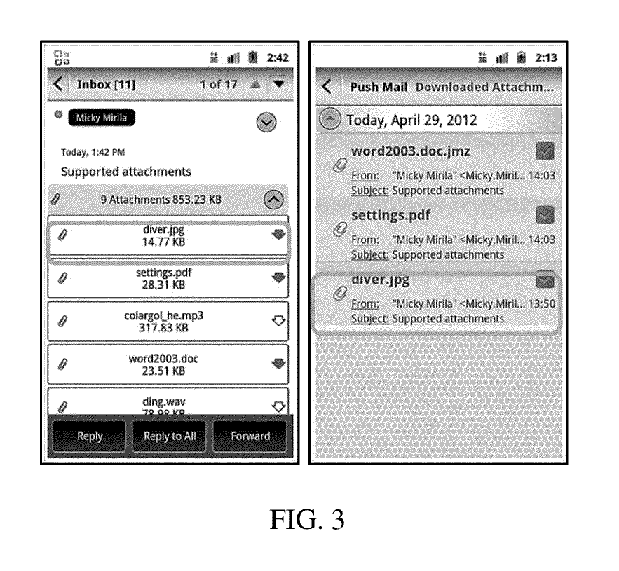

A user of a mobile device may download attachments included in email messages from a plurality of different email accounts through email applications configured to access the email accounts on the operating system. The user may download attachments included in other messages, e.g., SMS messages, through corresponding applications configured to access the messages. As shown in FIG. 2, the user may select and open an attachment to an email from a list of emails in an email account. For example, as shown in FIG. 2, the attachment comprising the file driver.jpg may be selected and downloaded by the user. An attachment may include any type of file or data which can be included in an email message or other message as an attachment. If the user executes the Downloaded Attachments application, the application displays a link for the downloaded attachment in the displayed list of links of downloaded attachments. The user can thus verify that the attachment has been downloaded, view the attachment by clicking on its corresponding link in the list or, if more than one attachment has been downloaded, sort the list of attachments based on various information included in the attachments as described below. FIG. 3 is an example display of an email and a display of links for downloaded attachments. For example, as shown in FIG. 3, the attachment comprising the file driver.jpg is shown in both the email and in the list of links of downloaded attachments displayed by the Downloaded Attachments application.

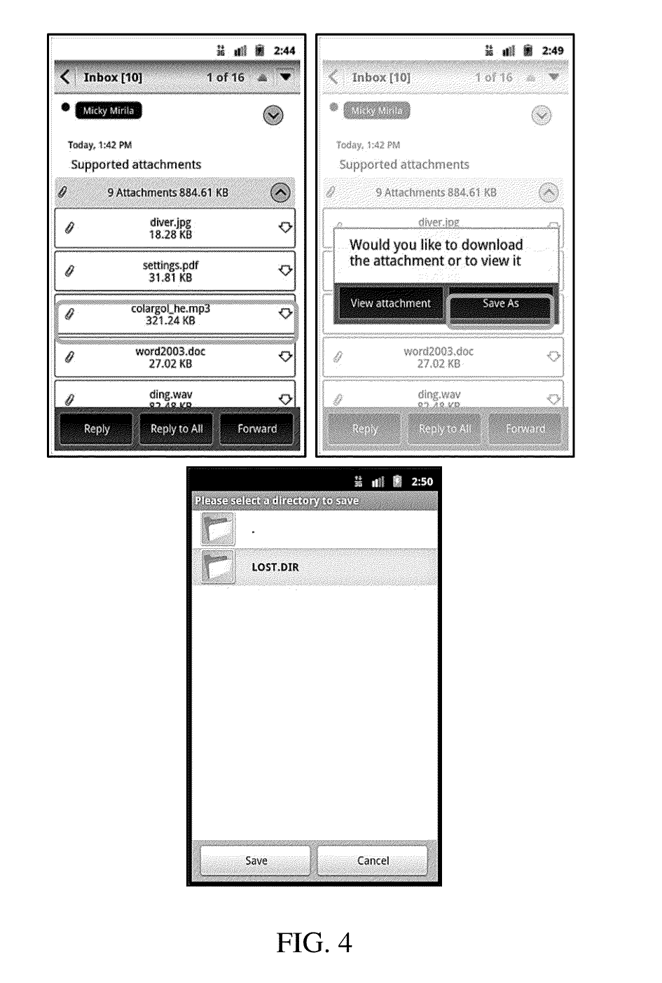

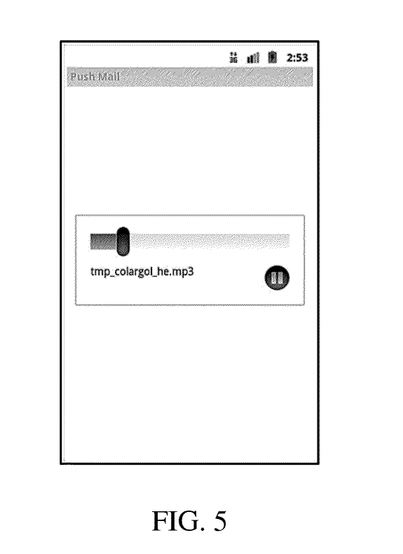

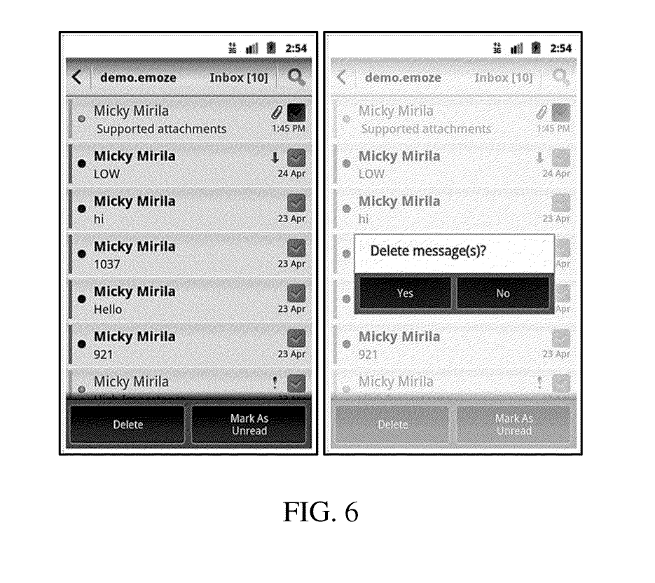

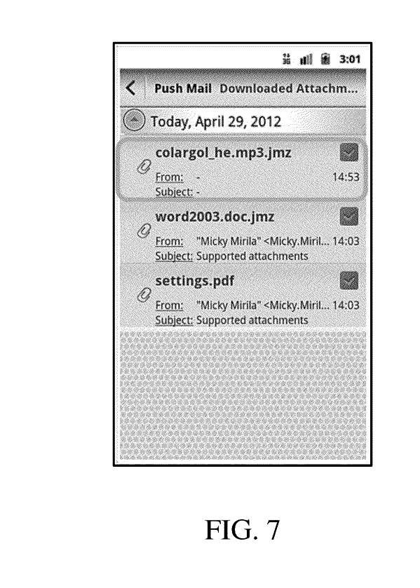

As shown in FIG. 4, the user may select and save an attachment included in an email message from a list of attachments in an email. The user may save the attachment to the mobile device. For example, as shown in FIG. 4, the user may save the attachment comprising the file colargol_he.mp3 to the mobile device. The email including the attachment comprising the file colargol_he.mp3 may be saved on the mobile device so that it is linked or connected to the saved attachment. FIG. 5 is an example display showing playback of a downloaded attachment. As shown in FIG. 6, the user may delete the email messages containing the downloaded attachments, e.g., the messages containing the files driver.jpg and colargol_he.mp3, from the email account of the user. If the user now opens the Downloaded Attachments application as shown in FIG. 7, the attachment which was downloaded and saved by the user (i.e., colargol_he.mpg, see FIG. 4) is displayed in the list of downloaded attachments shown in FIG. 7. However, the attachment which was downloaded only temporarily for viewing, and not saved by the user, is no longer displayed in the list of downloaded attachments shown in FIG. 7. Accordingly, the Downloaded Attachments application may display a list including links to all downloaded attachments, but links for attachments which are downloaded, but not saved to the mobile device, are removed from the list of links if the email message corresponding to the attachment is deleted from the user's email account. For example, if the user selects the open/preview option for downloading an attachment, a link for the previewed attachment may not be available in the list of links only while the previewed attachment is opened. After the previewed attachment is closed, its link is removed from the list of links and the attachment is deleted from temporary memory.

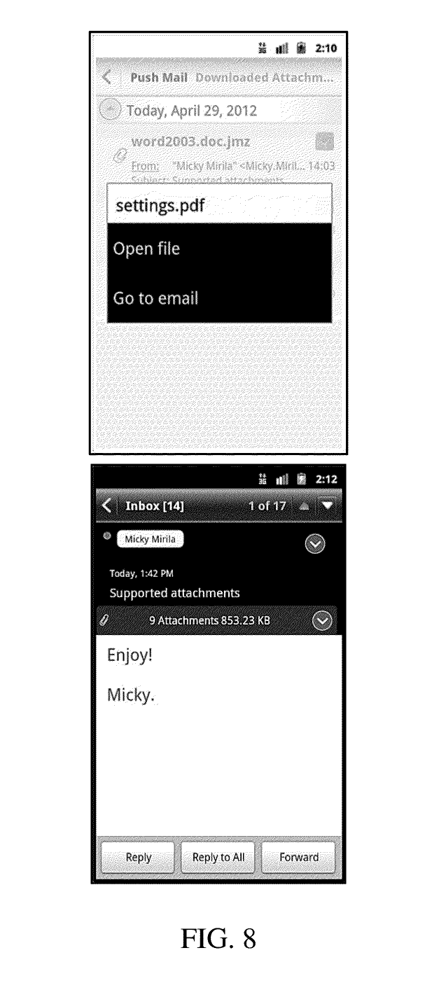

If the user opens the Downloaded Attachments application and selects a link for a particular attachment in the resulting display, the user may view the email corresponding to the particular attachment, as shown in FIG. 8. For example, the user may tap and hold a link for a particular attachment to open a sub-display that allows the user to choose between opening the particular attachment or opening the email corresponding to the particular attachment on the mobile device. If the user selects the open email option, the email that included the particular attachment is opened directly by the Downloaded Attachments application in the same display.

A user selects a Downloaded Attachments button or link on a screen of the mobile device to start the Downloaded Attachments application. The screen may be a main home screen of a mobile operating system or an applications screen displaying a list of applications executable by the mobile device or any other screen that provides buttons or links for applications. For example, an application for the user's home email account may include the Downloaded Attachments button or link. The main screen may be displayed on the display by the operating system executed by the mobile device.

The Downloaded Attachments button executes the Downloaded Attachments application or process which displays a list of links for all of the attachments that have been downloaded by the user on the mobile device. The list of downloaded attachments may be ordered by dates of the downloaded attachments; however, example embodiments are not limited thereto and the list of downloaded attachments may be ordered by any other feature or information associated with the downloaded attachments, e.g., a name, a type, a size, or a date modified. The user of the mobile device may select the type of ordering used by the Downloaded Attachments application to display the links on the display. The links to the attachments may be displayed as icons or tiles instead of in a list, and various information associated with the attachments may be displayed with the list or the icons or tiles for the attachments in the display. For example, the name, the type, the size, the date modified and/or the date downloaded of the attachment may be displayed with the link for that attachment in the list or the icon or tile for the attachment in the display. Furthermore, a sender name or names and/or a subject of the email message from which the attachment was downloaded (and any other attribute of the email message) may be displayed with the link for the attachment in the list or with the corresponding icon or tile in the display.

The Downloaded Attachments application thus provides a single location, e.g., a single application or a single application display or window, that enables easy access to all of the attachments that have been downloaded by the user on the mobile device. The user no longer needs to scan through the emails in multiple email accounts to locate a particular attachment. The user no longer needs to search for an email within an account or remember in which account the attachment is located.

The user may select any of the attachments in the list of links or from the icons or tiles representing the attachments to view or open the selected attachment on the mobile device and/or to view or open the message including the attachment. The user may directly open an attachment within the Downloaded Attachments application window. Alternatively or additionally, the user may directly open the corresponding email of the attachment within the Downloaded Attachments application window so that the user can access and open the email that the attachment was downloaded from.

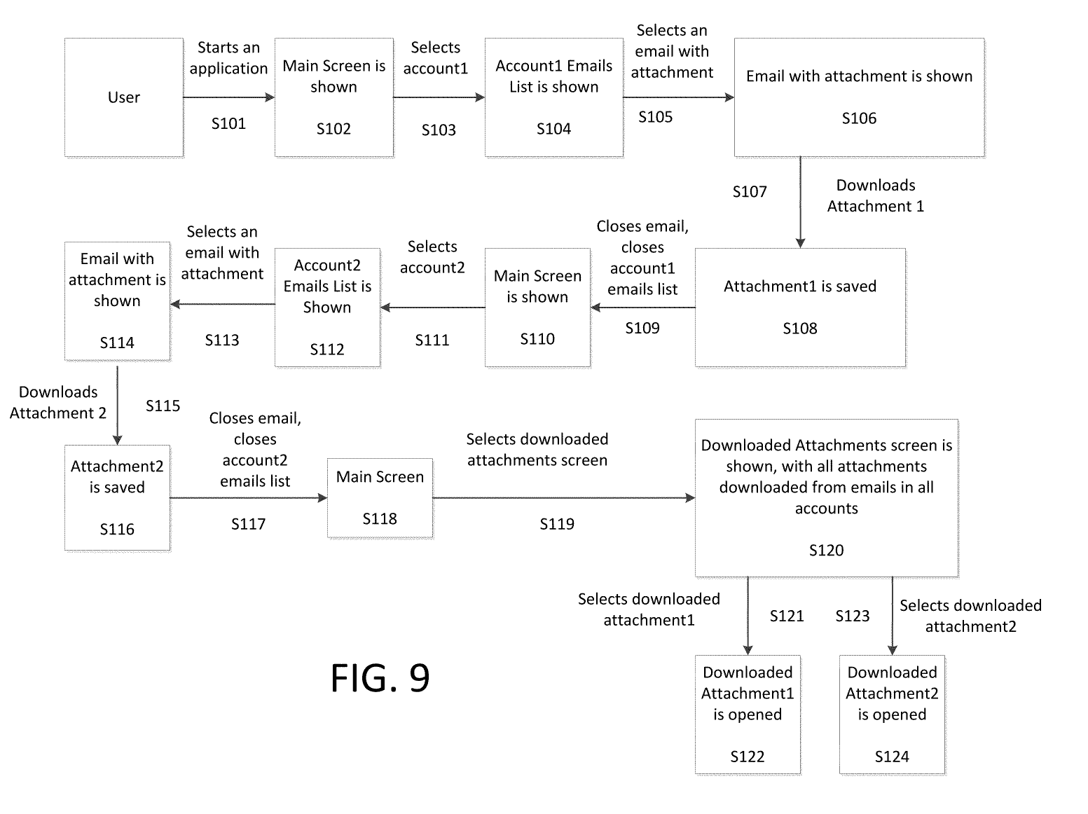

FIG. 9 is a flow chart showing a method for downloading, organizing and accessing attachments to messages. For example, an attachment for a deleted email, e.g., after an automatic clean-up operation, may still be accessible in the Downloaded Attachments application. A user may select the Downloaded Attachments button or icon to start the Downloaded Attachments application at S101. As previously described, the Downloaded Attachments application or process displays a list of links (see FIG. 1) for all of the attachments that have been downloaded by the user on the mobile device at S102. To add an attachment to the list of downloaded attachments in the Downloaded Attachments application, the attachment must be downloaded to the mobile device. The user, at S103, selects a first email account, for example by selecting a button or icon to start an application for the first email account. A list of emails is displayed by the application for the first email account at S104. The user selects an email with an attachment in the list of emails in the first email account at S105. The email with the attachment may be displayed at S106, and downloaded at S107 in response to selection by the user. The attachment to the email is saved by the user at S108. The user exits the first email account at S109, and the main display is displayed again at S110.

The user, at S111, selects a second email account, for example by selecting a button or icon to start an application for the second email account. A list of emails is displayed by the application for the second email account at S112. The user selects an email with an attachment in the list of emails in the second email account at S113. The email with the attachment may be displayed at S114, and downloaded at S115 in response to selection by the user. The attachment to the email is saved by the user at S116. The user exits the second email account at S117, and the main display is displayed again at S118.

The user selects the Downloaded Attachments button or link on the main screen to start the Downloaded Attachments application. As previously described, the Downloaded Attachments application or process displays a list of links (see FIG. 1) of all of the attachments that have been downloaded by the user on the mobile device at S120. For example, the Downloaded Attachments application or process now displays the attachment downloaded from the email in the first email account and the attachment downloaded from the email in the second email account. The user may select the attachment downloaded from the email in the first email account at S121, and the downloaded attachment is directly opened at S122 for viewing by the user in the Downloaded Attachments application. Alternatively, or additionally, the email including the attachment downloaded from the first email account may be directly opened for viewing by the user in the Downloaded Attachments application. The user may select the attachment downloaded from the email in the second email account at S123, and the downloaded attachment is directly opened at S124 for viewing by the user in the Downloaded Attachments application. Alternatively, or additionally, the email including the attachment downloaded from the second email account may be directly opened for viewing by the user in the Downloaded Attachments application.

Although example embodiments have been shown and described in this specification and figures, those skilled in the art will appreciate that various changes may be made to the illustrated and/or described example embodiments without departing from their principles and spirit.

What is claimed is:

1. A method for organizing and accessing attachments to messages, the method comprising:
downloading, by a mobile device, a plurality of attachments to messages from a plurality of different message accounts;
displaying, by the mobile device, a plurality of links for the plurality of attachments by a single application in a single location.

2. The method according to claim 1, wherein the messages from the plurality of different message accounts comprise emails from a plurality of different email accounts.

3. The method according to claim 2, wherein the messages from the plurality of different message accounts further comprise at least one of a short message service (SMS) message, an instant message and a social networking message.

4. The method according to claim 1, wherein the plurality of links are organized by at least one of download dates of the downloaded attachments, names of the downloaded attachments, types of the downloaded attachments, sizes of the downloaded attachments, and modified dates of the downloaded attachments.

5. The method according to claim 1, wherein the links are displayed in the single location in one of a list view, an icon view and a tile view.

6. The method according to claim 5, further comprising selecting, by a user of the mobile device, one of the list view and the icon view.

7. The method according to claim 1, wherein at least one of virtual locations and physical locations of the plurality of downloaded attachments are located in the single location.

8. The method according to claim 1, further comprising:
selecting an attachment of the plurality of attachments displayed in the single location;
accessing and viewing the attachment directly from the single location.

9. The method according to claim 1, further comprising
selecting a link for an attachment of the plurality of attachments displayed by the single application in the single location;
directly accessing and viewing in the single location an email corresponding to the selected attachment by the single application.

10. The method according to claim 1, further comprising:
displaying information for each said attachment with the link therefor.

11. The method according to claim 1, further comprising:
individually downloading the plurality of attachments to messages from the plurality of different message accounts.

12. The method according to claim 1, further comprising:
automatically downloading the plurality of attachments to messages from the plurality of different message accounts.

13. A system for organizing and accessing attachments to messages on a mobile device, comprising:
a download unit configured to download to the mobile device a plurality of attachments to messages from a plurality of different message accounts;
a display unit configured to display on the mobile device a plurality of links for the plurality of attachments by a single application in a single location.

14. The system according to claim 13, wherein the messages from the plurality of different message accounts comprise emails from a plurality of different email accounts.

15. The system according to claim 14, wherein the messages from the plurality of different message accounts further comprise at least one of a short message service (SMS) message, an instant message and a social networking message.

16. The system according to claim 13, wherein the plurality of links are organized by at least one of download dates of the downloaded attachments, names of the downloaded attachments, types of the downloaded attachments, sizes of the downloaded attachments, and modified dates of the downloaded attachments.

17. The system according to claim 13, wherein the links are displayed in the single location in one of a list view, an icon view and a tile view.

18. The system according to claim 17, wherein a user of the mobile device selects one of the list view and the icon view.

19. The system according to claim 13, wherein at least one of virtual locations and physical locations of the plurality of downloaded attachments are located in the single location.

20. The system according to claim 13, wherein the display unit is configured to open and display a selected attachment of the plurality of attachments displayed in the single location directly from the single location.

21. The system according to claim 13, wherein the display unit is configured to open and display in the single location by the single application an email corresponding to a selected attachment of the plurality of attachments displayed by the single application in the single location.

22. The system according to claim 13, wherein the display unit is configured to display information for each said attachment with the link therefor.

23. The system according to claim 13, wherein the download unit is configured to individually download the plurality of attachments to messages from the plurality of different message accounts.

24. The system according to claim 13, wherein the download unit is configured to automatically download the plurality of attachments to messages from the plurality of different message accounts.

25. A non-transitory computer readable medium storing a computer program which when executed by a processor of a mobile devices causes the processor to execute steps of a method for organizing and accessing attachments to messages, the method comprising:
downloading a plurality of attachments to messages from a plurality of different message accounts;
displaying a plurality of links for the plurality of attachments by a single application in a single location.
